(19) United States
(12) Patent Application Publication
(10) Pub. No.: US 2025/0105633 A1
(43) Pub. Date: Mar. 27, 2025

(54) POWER CONTROL DEVICE

(71) Applicant: NTT DOCOMO, INC., Tokyo (JP)

(72) Inventors: Masaki NAKAMURA, Chiyoda-ku (JP); Yuta TOYAMA, Chiyoda-ku (JP); Kazuhiko TAKENO, Chiyoda-ku (JP)

(73) Assignee: NTT DOCOMO, INC., Tokyo (JP)

(21) Appl. No.: 18/729,075

(22) PCT Filed: Feb. 20, 2023
(86) PCT No.: PCT/JP2023/006044

§ 371 Date: Jul. 15, 2024

(30) Foreign Application Priority Data
Apr. 5, 2022 (JP) 2022-062961

(51) Int. Cl. H02J 7/00; H02J 7/04

(52) U.S. Cl. CPC H02J 7/00032; H02J 7/00302; H02J 7/0049; H02J 7/0063; H02J 7/0071; H02J 7/00712; H02J 7/007188; H02J 7/04; H02J 2310/14

(57) ABSTRACT

The purpose is to perform control so that a sufficient amount of stored power is secured when a DR request signal is received.

A HEMS 100 is a power control device, which is a power control device that controls a storage battery 400 for supplying power to a communication device 500 that is a load device. In the HEMS 100, a DR activation prediction unit 103 predicts the activation of a demand response. A charge/discharge determination unit 108, which is a control unit, performs discharge control on the storage battery 400 based on this activation prediction. The charge/discharge determination unit 108 changes the discharge timing of the storage battery 400 depending on whether or not the activation of a demand response is predicted.

### TECHNICAL FIELD

The present invention relates to a power control device for supplying power to a load device such as a wireless base station.

### BACKGROUND ART

Since the amount of power generated by natural energy such as solar power generation and wind power generation increases or decreases depending on the weather (the amount of solar radiation, the amount of wind, and the like), power adjustment that can flexibly respond to such fluctuations is required. One of these measures is demand response (DR). Through this DR, the power supply company requests customers to reduce their power consumption, and incentives such as rewards are given according to the amount of reduction for each customer.

Patent Literature 1 describes a power management method that makes it possible to appropriately determine the amount of power discharged from a storage battery for peak cut and the amount of power discharged from a storage battery for demand response.

### CITATION LIST

### Patent Literature

Patent Literature 1: Japanese Unexamined Patent Publication No. 2015-186290

### SUMMARY OF INVENTION

### Technical Problem

The use of storage batteries is considered to be an effective means for reducing peak power demand. By storing power when power demand is low and discharging the stored power when power demand increases, the load on the power system can be reduced, leading to a reduction in peak power demand. In addition, it is possible to reduce power costs by signing up for a power rate plan that has different unit prices depending on the time of the day, such as cheap nighttime power. Therefore, it is thought that by utilizing storage batteries as backup power sources in base stations forming a mobile communication network even under normal circumstances, it is possible to contribute to power supply and demand through DR.

Incidentally, in the invention described in Patent Literature 1, charge/discharge control on the storage battery is performed based on the time of request through the DR. Therefore, in services that require a fast response time, such as Fast DR, there is a possibility that a sufficient amount of stored power may not be secured when a DR request signal is received. In this case, there is a problem that it is not possible to respond to DR requests.

Therefore, it is an object of the present invention to provide a power control device that performs control so that a sufficient amount of stored power is secured when a DR request signal is received.

### Solution to Problem

A power control device of the present invention is a power control device for controlling a storage battery to supply power to a load device, and includes: a prediction unit that predicts activation of a demand response; and a control unit that performs discharge control on the storage battery based on the activation prediction. The control unit changes a discharge timing of the storage battery depending on whether or not the activation of the demand response is predicted.

### Advantageous Effects of Invention

According to the present invention, since a sufficient amount of stored power is secured when a DR request signal is received, it is possible to sufficiently respond to Fast DR and the like.

### BRIEF DESCRIPTION OF DRAWINGS

FIG. 1 is a block diagram showing an overview of a DC power supply system 10 of the present disclosure.

FIG. 2 is a block diagram showing the detailed functional configuration of a rectifier 300.

FIG. 3 is a block diagram showing the functional configuration of a HEMS 100 according to a first embodiment of the present disclosure.

FIG. 4 is a flowchart showing the operation of the HEMS 100.

FIG. 5 is a conceptual diagram of charge/discharge control.

FIG. 6 is a block diagram showing the functional configuration of a HEMS 100a according to a second embodiment.

FIG. 7 is a flowchart showing the operation of the HEMS 100a according to the second embodiment.

FIG. 8 is a diagram showing an example of the hardware configuration of the HEMS 100 according to an embodiment of the present disclosure.

### DESCRIPTION OF EMBODIMENTS

Embodiments of the present disclosure will be described with reference to the accompanying diagrams. Whenever possible, the same portions are denoted by the same reference numerals, and repeated descriptions thereof will be omitted.

### First Embodiment

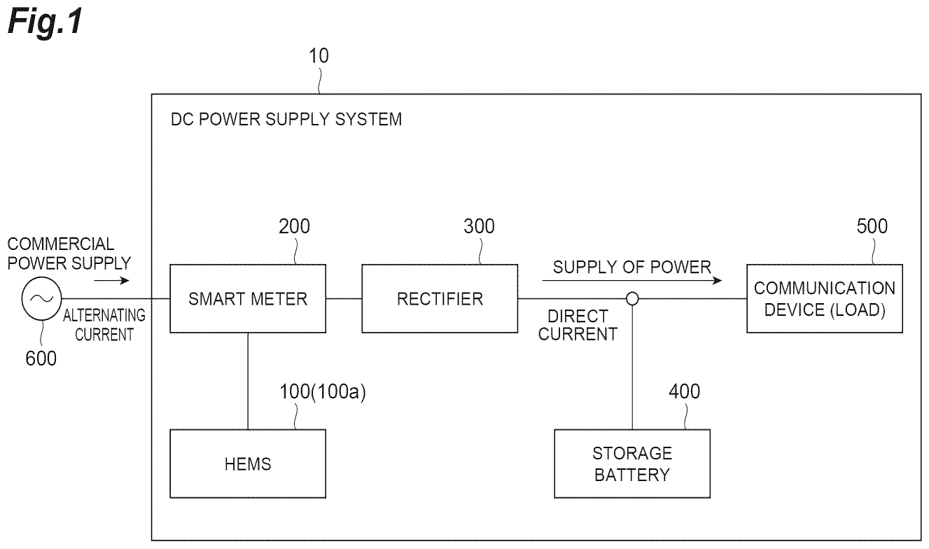

A DC power supply system 10 of a wireless base station in the present disclosure will be described. FIG. 1 is a block diagram showing an overview of the DC power supply system 10 of the present disclosure. As shown in FIG. 1, the DC power supply system 10 includes a home energy management system (HEMS) 100, a smart meter 200, a rectifier 300, a storage battery 400, and a communication device 500 (load) to which DC power is supplied.

The HEMS 100 is a device that acquires power information of the smart meter 200 required for DR and controls charging and discharging of the storage battery 400 with respect to the rectifier 300.

The smart meter 200 is a measuring device that measures the amount of power used that is supplied from a commercial power supply 600.

The rectifier 300 is a circuit that converts alternating current supplied from the commercial power supply 600 into direct current.

The communication device 500 is a wireless base station forming a mobile communication network, and corresponds to a load device. The communication device 500 receives the supply of power from the storage battery 400 or the commercial power supply 600 to perform a communication operation. In addition, although not shown, the communication device 500 may be configured to receive the supply of power obtained by solar power generation.

The commercial power supply 600 indicates a source of generated power, and typically indicates a power company.

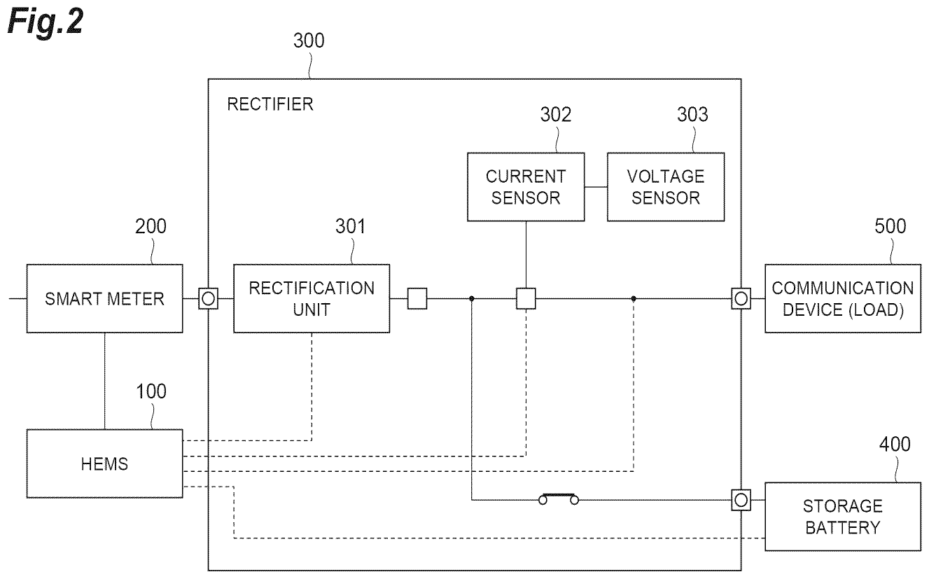

FIG. 2 is a block diagram showing the detailed functional configuration of the rectifier 300. As shown in the diagram, the rectifier 300 includes a rectification unit 301, a current sensor 302, and a voltage sensor 303.

The rectification unit 301 controls a rectifier voltage thereinside to control the supply of power to the communication device 500, charging to the storage battery 400, or discharging of the storage battery 400 (supply of power from the storage battery 400 to the communication device 500).

The current sensor 302 is a portion that measures a current output from the rectification unit 301.

The voltage sensor 303 is a portion that measures an output voltage from the rectification unit 301.

The HEMS 100 can acquire the current and the voltage measured by the current sensor 302 and the voltage sensor 303 and control the rectification unit 301 based on the acquired current and voltage.

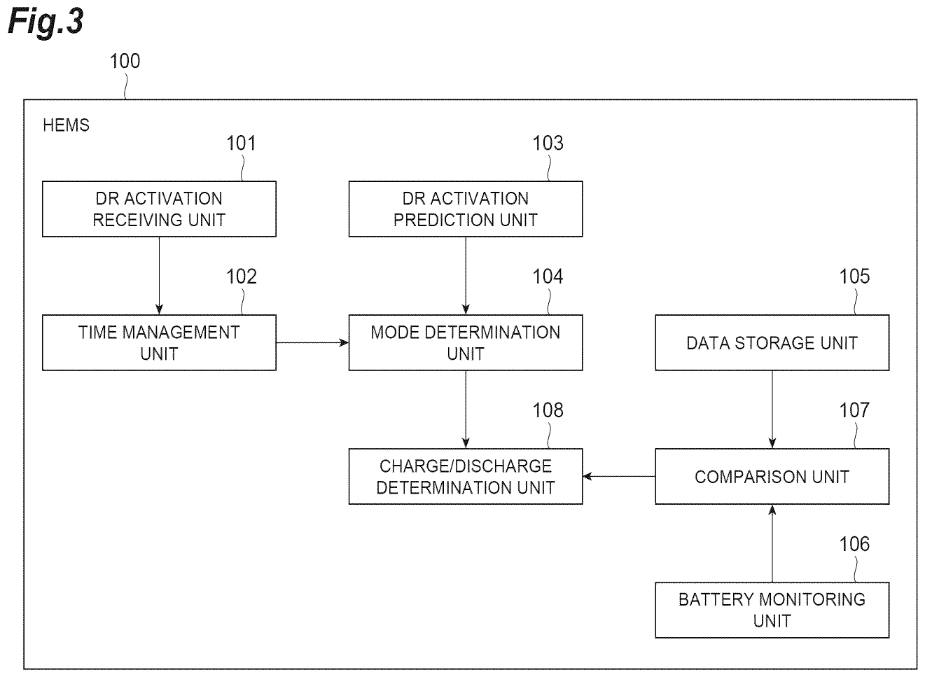

FIG. 3 is a block diagram showing the functional configuration of the HEMS 100 according to the first embodiment of the present disclosure. As shown in the diagram, the HEMS 100 includes a DR activation receiving unit 101, a time management unit 102, a DR activation prediction unit 103, a mode determination unit 104, a data storage unit 105, a battery monitoring unit 106, a comparison unit 107, and a charge/discharge determination unit 108.

The DR activation receiving unit 101 is a unit that receives a DR request signal from a power company or the like. This DR request signal includes a DR activation time t1 and a DR end time t2. The DR activation time t1 indicates a time when the demand side starts suppressing power consumption based on the DR request, and in the present disclosure, indicates a time when the rectifier 300 performs a process of suppressing consumption, that is, a process of discharging the storage battery 400. The DR end time t2 indicates a time when the DR request ends, and in the present disclosure, indicates a time when the discharge of the storage battery 400 ends.

The time management unit 102 stores a discharge start time to of the peak hours of power consumption and a time zone (for example, a time zone of nighttime) in which the unit price of power is different. In addition, the time management unit 102 extracts the DR activation time t1 and the DR end time t2 from the DR request signal and stores the DR activation time t1 and the DR end time t2.

The DR activation prediction unit 103 is a unit that performs activation prediction for DR (hereinafter, referred to as DR activation prediction). The DR activation prediction is realized by performing a calculation based on a neural network or logistic regression using a predicted power usage rate presented by the power supply company, wholesale power prices at the wholesale power exchange, and parameters highly relevant to power demand (for example, parameters such as weather).

In addition, the DR activation prediction is not limited to the method described above. In addition, for example, the DR activation prediction unit 103 may acquire the power supply capacity, the expected amount of power to be used or past power usage record data, and past DR record data from the power supply company, and predict the DR activation time based on these. Specifically, the DR activation prediction unit 103 predicts a time zone, during which there will be a power shortage, from the power supply capacity and the expected amount of usage or the power usage record data, and predicts a time zone slightly before the time zone (before predetermined time) as the DR activation time.

In addition, as another method, prediction may be made from record data such as a relationship between the past DR execution date and time and the power demand before and after the execution date and time.

The mode determination unit 104 is a unit that determines discharge control and DR control during the peak hours of power consumption under normal circumstances based on the result of DR activation prediction. More specifically, after the DR activation prediction is made, the mode determination unit 104 acquires a DR activation time included in the DR request signal received by the DR activation receiving unit 101, and causes the charge/discharge determination unit 108 to start DR control for the storage battery 400 by comparing the DR activation time with the current time. In addition, when the DR end time comes, the mode determination unit 104 ends the DR control process.

In addition, when the DR activation prediction is not made, the mode determination unit 104 performs discharge control for the storage battery 400 when the current time t reaches the discharge start time to set according to the peak hours.

The data storage unit 105 is a unit that stores the lower limit SOC (State of Charge) of the storage battery 400.

The battery monitoring unit 106 is a unit that monitors (acquires) the current SOC (at the time of monitoring) of the storage battery 400.

The comparison unit 107 is a unit that compares the lower limit SOC with the current SOC.

The charge/discharge determination unit 108 is a unit that performs charge/discharge control on the storage battery 400 based on the discharge control or DR control by the mode determination unit 104 and the comparison result of the comparison unit 107.

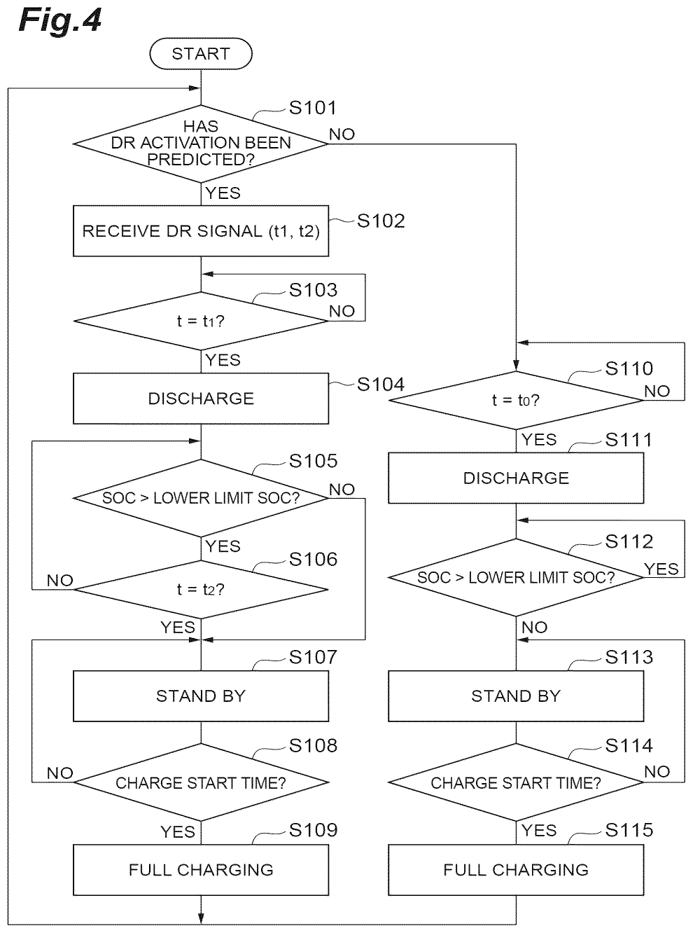

Next, the operation of the HEMS 100 configured as described above will be described. FIG. 4 is a flowchart showing the operation of the HEMS 100.

The DR activation prediction unit 103 determines whether or not a DR activation prediction has been made (S101). Here, when the prediction is made, operations from steps S102 to S109 are performed. In addition, the prediction process is performed before time to of normal charge/discharge control.

The DR activation receiving unit 101 receives a DR request signal (S102). This DR request signal includes the DR activation time t1 and the DR end time t2. Then, the mode determination unit 104 determines whether or not the current time t matches the DR activation time t1 (S103). When it is determined that these match, the charge/discharge determination unit 108 performs discharge control on the storage battery 400 (S104).

The comparison unit 107 determines whether or not the SOC of the storage battery 400 is greater than the lower limit SOC (S105).

In addition, the mode determination unit 104 determines whether or not the current time t has reached the DR end time t2 (S106).

When the SOC is greater than the lower limit SOC and the current time t has reached the DR end time t2 (S106: YES) or when the SOC is not greater than the lower limit SOC (S105: NO), the charge/discharge determination unit 108 ends the process of discharging the storage battery 400 and stands by (S107).

Then, when a predetermined charge start time comes (S108: YES), the charge/discharge determination unit 108 performs charge control on the storage battery 400 until the storage battery 400 becomes full (or a predetermined SOC) (S109). The charge start time is set to, for example, a time zone during which the price of power from the commercial power supply 600 is low at night.

In addition, when the DR activation prediction is not made in step S101, the mode determination unit 104 determines whether or not the current time t has reached the discharge start time to (S110). This discharge start time to indicates a time of discharge start that is periodically performed when there is no DR request, and is set in advance. When the mode determination unit 104 determines whether or not the current time t has reached the discharge start time to, the charge/discharge determination unit 108 performs discharge control on the storage battery 400 (S111).

When the SOC is not greater than the lower limit SOC (S112: NO), the charge/discharge determination unit 108 ends the process of discharging the storage battery 400 and stands by (S113).

Then, when the predetermined charge start time comes (S114: YES), the charge/discharge determination unit 108 performs charge control on the storage battery 400 until the storage battery 400 becomes full (or a predetermined SOC) (S115). The charge start time is set to, for example, a time zone during which the price of power from the commercial power supply is low at night.

In addition, if DR is activated when the DR activation prediction is not made, discharge is performed during the DR activation period with priority over discharge control under normal circumstances. In addition, when discharge under normal circumstances is being performed, the discharge is performed as it is. Then, when the lower limit SOC is reached, priority is given to securing a backup and the system shifts to a standby state, similar to the control under normal circumstances. Then, when the charge start time comes, charging starts.

On the other hand, when DR activation is predicted but DR is not activated, the fully charged state is maintained until the next day. That is, this is a state in which neither the discharge control under normal circumstances nor the DR control is performed.

With such a configuration, it is possible to respond to Fast DR, so that there is no situation in which the SOC of the storage battery 400 is insufficient when DR is received.

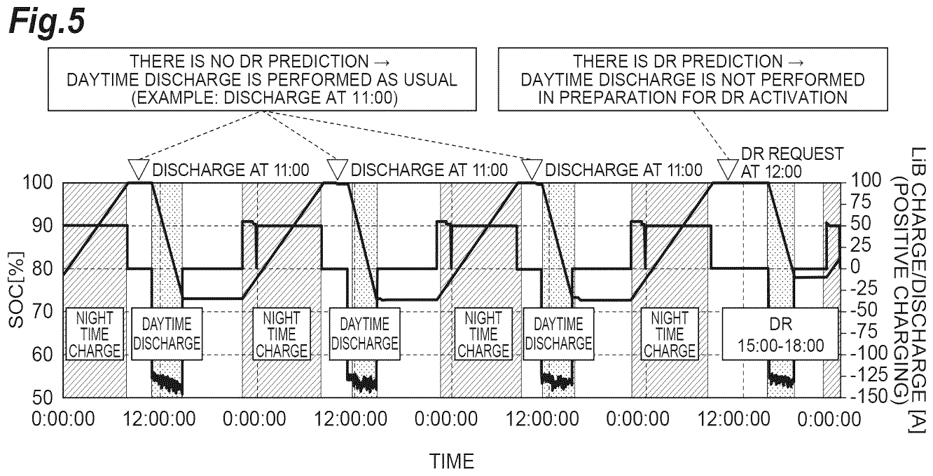

FIG. 5 is a conceptual diagram of charge/discharge control. As shown in the diagram, when DR activation is not made, daytime discharge is performed as usual. For example, in the diagram, discharge starts at 11:00, which is the discharge start time to. On the other hand, when there is a DR activation prediction, daytime discharge is not performed in preparation for the DR activation. That is, discharge under normal circumstances is not performed. When a DR request signal is received, discharge is performed based on the DR activation time. In the diagram, the DR activation time t1 is set to 12:00.

FIG. 5 shows transition graphs of battery SOC and LiB charge/discharge.

Here, discharge and charge control will be described. As shown in FIG. 2, the rectifier 300 includes the rectification unit 301, a current sensor, a voltage sensor, and the like, and can supply power to the communication device 500 and the storage battery 400.

The HEMS 100 (charge/discharge determination unit 108) controls the rectifier voltage of the rectifier 300 so that the rectifier 300 can charge and discharge the communication device 500 or the storage battery 400. For example, when DR activation is not predicted, the HEMS 100 sets the rectifier voltage to a value (for example, 45 V) sufficiently lower than the battery voltage (voltage of the storage battery 400) at the discharge start time to and accordingly, the storage battery 400 starts discharging. Then, when the SOC of the storage battery 400 reaches the lower limit SOC, the HEMS 100 (charge/discharge determination unit 108) sets the rectifier voltage to be approximately the same as the storage battery voltage (for example, 48 V) and accordingly, the storage battery 400 becomes in a standby state. Thereafter, when the charge start time comes, the rectifier voltage is set to a value (for example, 54 V) sufficiently higher than the storage battery voltage and accordingly, the storage battery 400 starts charging.

On the other hand, when DR is predicted, the HEMS 100 does not perform discharge even at the discharge start time t0 and prepares for a DR request. Then, when a DR request is received and the DR activation time t1 comes, the charge/discharge determination unit 108 sets the rectifier voltage to a value (for example, 45 V) sufficiently lower than the storage battery voltage and accordingly, the storage battery 400 starts discharging. Then, when the SOC of the storage battery 400 reaches the lower limit SOC or when the DR end time t2 comes, the HEMS 100 sets the rectifier voltage to be approximately the same as the storage battery voltage (for example, 48 V) and accordingly, the storage battery 400 becomes in a standby state. Thereafter, when the charge start time comes, the rectifier voltage is set to a value (for example, 54 V) sufficiently higher than the storage battery voltage and accordingly, the storage battery 400 starts charging.

Here, the determination of the lower limit SOC will be described. The HEMS 100 can derive an estimated load value Q by multiplying the value of the bus voltage of the DC power supply system 10 by the value of the current flowing to the communication device 500. Specifically, when the bus voltage of the DC power supply system 10 is 50 V and the current value is 60 A, the estimated load value Q can be obtained to be 3 kW by multiplying these values. Assuming that the storage battery capacity of the storage battery 400 is 50 kWh and the backup time to be secured is 10 hours, the backup capacity of the storage battery 400 to be secured is 30 kWh. On the other hand, at this time, assuming that the nighttime hours during which the power rate is cheap are 8 hours and the charging power is 2 kW, the minimum remaining battery capacity required for full charging during the nighttime hours during which the power rate is cheap is 34 kWh (value obtained by subtracting the charging amount 16 kWh (8 hours x charging power 2 kW) during the nighttime hours from the storage battery capacity 50 kWh). Since the larger one of these capacities is selected as a lower limit SOC, 68% obtained by dividing 34 kWh by 50 kWh is the lower SOC in this case.

### Second Embodiment

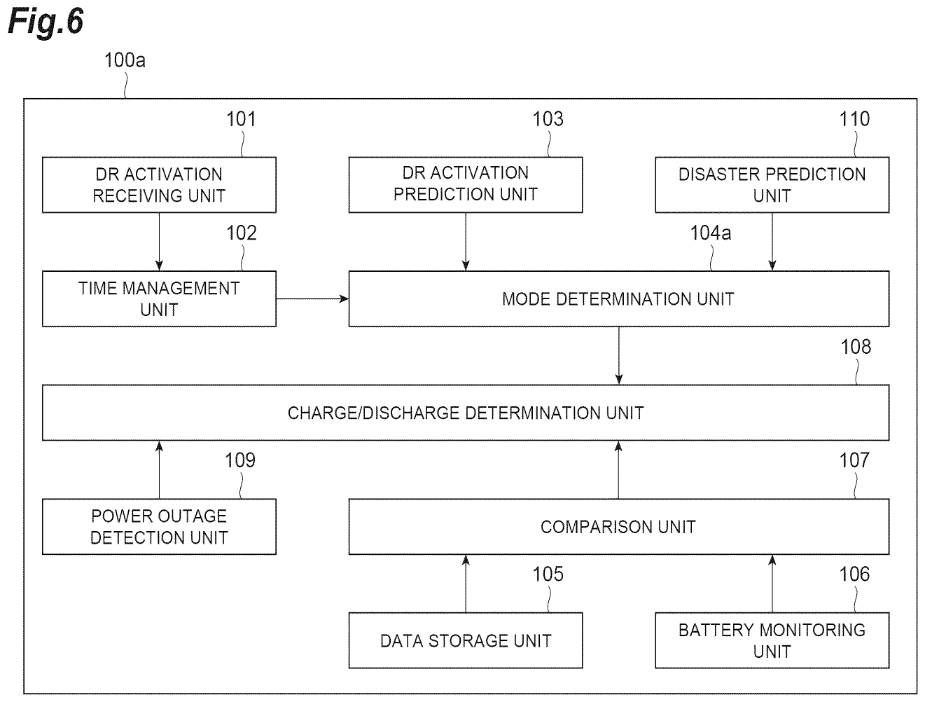

Next, a HEMS 100a according to a second embodiment will be described. FIG. 6 is a block diagram showing the functional configuration of the HEMS 100a according to the second embodiment. As shown in the diagram, the HEMS 100a includes a DR activation receiving unit 101, a time management unit 102, a DR activation prediction unit 103, a mode determination unit 104, a data storage unit 105, a battery monitoring unit 106, a comparison unit 107, a charge/discharge determination unit 108, a power outage detection unit 109, and a disaster prediction unit 110.

The HEMS 100a according to the second embodiment is different from the HEMS 100 according to the first embodiment in that the HEMS 100a includes the mode determination unit 104a, the power outage detection unit 109, and the disaster prediction unit 110.

The mode determination unit 104a is a unit that determines a mode based on prediction information such as weather information from the disaster prediction unit 110. In the second embodiment, there are three modes of disaster, DR request, and normal.

The power outage detection unit 109 is a unit that detects the voltage of the rectifier 300 to detect the presence or absence of a power outage.

The disaster prediction unit 110 is a unit that acquires prediction information, such as weather information including typhoon course information, and predicts the occurrence of a disaster based on the prediction information. In addition to weather information, information such as earthquakes may be predicted.

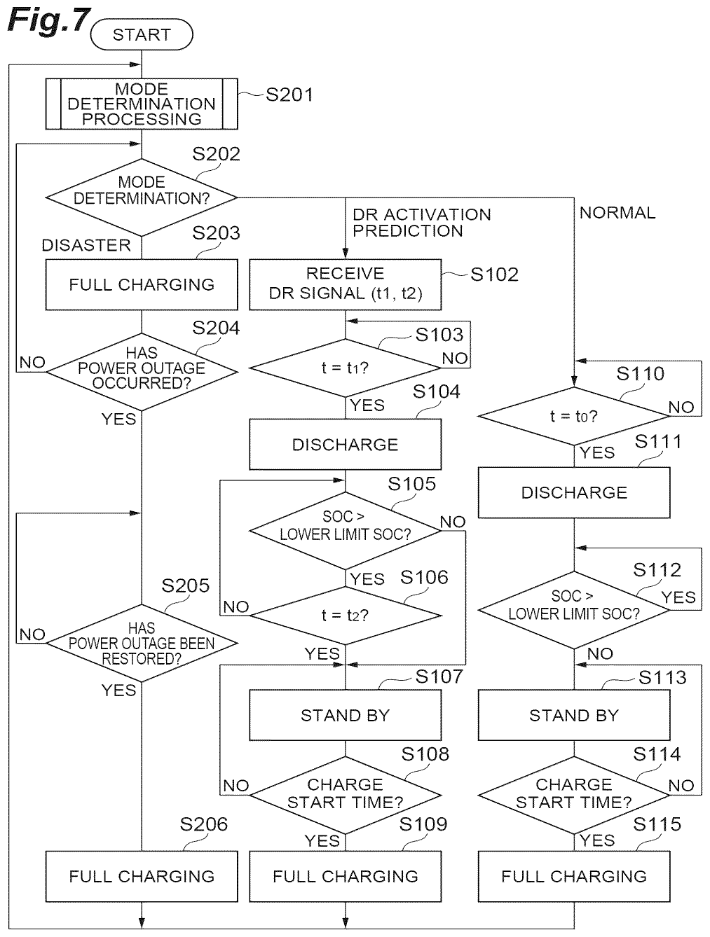

Next, the operation of the HEMS 100a according to the second embodiment will be described. FIG. 7 is a flowchart showing the operation of the HEMS 100a according to the second embodiment. The mode determination unit 104 performs mode determination processing to determine whether or not there is a DR activation prediction, whether or not there is a disaster prediction, or whether or not there is no prediction (S201). Then, when there is disaster prediction information, the mode determination unit 104 determines a disaster mode (S202: disaster). In the case of the disaster mode, the charge/discharge determination unit 108 performs charge control on the storage battery 400 until its SOC becomes full (S203).

Next, the power outage detection unit 109 detects whether or not a power outage has occurred (S204). Here, when the occurrence of a power outage is detected (S204: YES), the HEMS 100 discharges the battery until the power outage is restored (S205: NO). When the power outage is restored, that is, when the power outage detection unit 109 no longer detects the power outage state (S205: YES), the charge/discharge determination unit 108 performs charge control on the storage battery 400 until its SOC becomes full (or a predetermined SOC) (S206). In addition, when a DR activation prediction is received without disaster prediction or in the case of normal (a state in which there is neither disaster prediction nor DR activation prediction) (S202), the mode determination unit 104a performs the processing as described in the first embodiment. That is, when the DR activation prediction is received, the charge/discharge determination unit 108 performs discharge processing based on the DR activation time t1 and performs processing for ending the discharge based on the DR end time t2 (steps S102 to S109). In addition, under normal circumstances, the charge/discharge determination unit 108 performs discharge processing based on the discharge start time t0 during the peak hours of power consumption (steps S110 to S115).

Through such processing, when a disaster is predicted, the mode determination unit 104a determines to prepare for the disaster based on the information from the time management unit 102, the DR activation prediction unit 103, and the disaster prediction unit 110. On the other hand, when DR activation is predicted while no disaster is predicted, a determination is made to prepare for DR activation, and when neither a disaster nor DR activation is predicted, a determination is made to perform discharge control during the peak hours under normal circumstances.

In addition, for the charge/discharge control and the setting of the lower limit SOC of the storage battery 400, those described in the first embodiment can also be used in the second embodiment. [Modification examples]

In the DC power supply system 10 according to the embodiment described above, the HEMS 100 receives the DR request signal, but the rectifier 300 may be configured to receive the DR request signal.

In addition, the first and second embodiments are related to charge and discharge control on the storage battery 400. However, when the wireless base station includes a charge/discharge control device for the storage battery 400, charging/discharging/standby may be performed by controlling the charging and discharging of the storage battery 400 instead of controlling the rectifier voltage.

In addition, in the first and second embodiments described above, the rectifier 300 includes a control unit, a current sensor, and a voltage sensor, but these may be provided outside the rectifier 300.

### Function and Effect of First and Second Embodiments

The HEMS 100 of the present disclosure is a power control device, which is a power control device that controls the storage battery 400 for supplying power to the communication device 500 that is a load device. In the HEMS 100, the DR activation prediction unit 103 predicts the activation of a demand response. The charge/discharge determination unit 108, which is a control unit, performs discharge control on the storage battery 400 based on this activation prediction. The charge/discharge determination unit 108 changes the discharge timing of the storage battery 400 depending on whether or not the activation of a demand response is predicted.

For example, when the activation of the demand response is not predicted, the charge/discharge determination unit 108 discharges the storage battery 400 at a predetermined peak time of power demand. On the other hand, when the activation of the demand response is predicted, the charge/discharge determination unit 108 discharges the storage battery 400 based on the activation time t1 included in a demand response request signal when the DR activation receiving unit 101 receives the demand response request signal.

Then, when the DR activation receiving unit 101 receives the demand response request signal, the charge/discharge determination unit 108 ends the discharge of the storage battery 400 based on the end time t2 included in the demand response request signal.

Then, when a predetermined charge start time comes after ending the discharge of the storage battery 400, the charge/discharge determination unit 108 performs control to charge the storage battery 400. In addition, when the demand response request signal is received, the charge/discharge determination unit 108 performs control to end the discharge of the storage battery 400 based on the state of charge (for example, SOC) of the storage battery 400.

Through such control, it is possible to perform control so that a sufficient amount of stored power is secured when a DR request signal is received.

The storage battery 400 controlled by the HEMS 100 of the present disclosure is charged with power from the commercial power supply 600 by the rectifier 300. The backup capacity (capacity to be charged in advance (SOC)) of the storage battery 400 is set based on the rectifier voltage of the rectifier 300 and the value of the current flowing through the communication device 500.

The charge/discharge determination unit 108 controls the discharge of the storage battery 400 based on the lower limit SOC set based on the backup capacity. This lower limit SOC is set as a reference for allowing discharge based on the time zone for charging the storage battery 400 and the charging power for the storage battery 400.

When the storage battery 400 reaches a fully charged state, the charge/discharge determination unit 108 sets the rectifier voltage of the rectification unit 301 to be approximately the same as the storage battery voltage to prevent overcharging.

In the second embodiment of the present disclosure, the HEMS 100a further includes the disaster prediction unit 110 that predicts the occurrence of a disaster. In addition, an acquisition unit that acquires information on disaster prediction may be provided. When the disaster prediction unit 110 predicts a disaster, the charge/discharge determination unit 108 performs a process of charging the storage battery 400 without waiting for the predetermined charge start time.

As a result, the storage battery 400 can be charged with a required SOC in advance.

In addition, the HEMS 100a further includes the power outage detection unit 109 that detects a power outage. When the power outage detection unit 109 detects a power outage, the charge/discharge determination unit 108 performs discharge processing regardless of the predetermined discharge start time to.

Therefore, it is possible to maintain a good state of charge of the storage battery and to respond to sudden activation of DR, such as Fast DR.

### [Regarding the Power Control Device of the Present Disclosure]

The functions of the power control device of the present disclosure can be combined as follows.
[1] A power control device for controlling a storage battery to supply power to a load device, including:
a prediction unit that predicts activation of a demand response; and a control unit that performs discharge control on the storage battery based on the activation prediction,
wherein the control unit changes a discharge timing of the storage battery depending on whether or not the activation of the demand response is predicted.
[2] The power control device according to [1],
wherein, when the activation of the demand response is not predicted, the control unit discharges the storage battery at a predetermined peak time of power demand, and
when the activation of the demand response is predicted, the control unit discharges the storage battery based on an activation time included in a demand response request signal when the demand response request signal is received.
[3] The power control device according to [2],
wherein, when the demand response request signal is received, the control unit ends the discharge of the storage battery based on an end time included in the demand response request signal. [4] The power control device according to [3],
wherein, when a predetermined charge start time comes after ending the discharge of the storage battery, the control unit charges the storage battery.
[5] The power control device according to any one of [1] to [4],
wherein, when a demand response request signal is received, the control unit ends discharge of the storage battery based on a state of charge of the storage battery.
[6] The power control device according to any one of [1] to [5],
wherein the storage battery is charged with power from a commercial power supply by a rectifier,
a backup capacity of the storage battery is set based on a rectifier voltage of the rectifier and a value of a current flowing through the load device, and
the control unit controls discharge of the storage battery based on a lower limit SOC set based on the backup capacity.
[7] The power control device according to [6],
wherein the lower limit SOC that is a reference for allowing discharge is set based on a charging time zone for the storage battery and charging power for the storage battery.
[8] The power control device according to claim [6] or [7],
wherein, when the storage battery reaches a fully charged state, the control unit sets the rectifier voltage of the rectifier to be approximately the same as a voltage of the storage battery to prevent overcharging.
[9] The power control device according to any one of [1] to [8], further including:
an acquisition unit that acquires a prediction or notification of occurrence of a disaster,
wherein, when a disaster is predicted, the control unit performs a process of charging the storage battery without waiting for a predetermined charge start time.
[10] The power control device according to any one of [1] to [9], further including:
a detection unit that detects a power outage,
wherein, when the power outage is detected, the control unit performs discharge processing regardless of a predetermined discharge start time.

### Hardware Configuration and Terminology Definitions

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

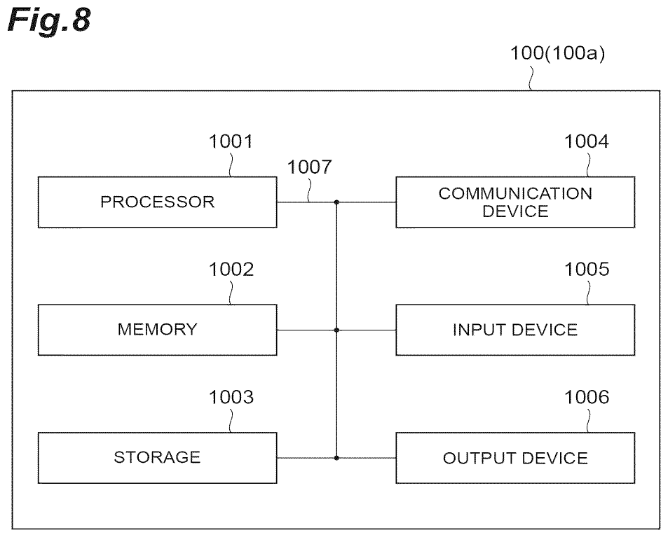

For example, the HEMS100 (hereafter, HEMS100 includes HEMS100a) according to one embodiment of the present disclosure may function as a computer that performs processing of a power control method according to the present disclosure. FIG. 8 is a view showing an example of the hardware configuration of the HEMS100 according to one embodiment of the present disclosure. The HEMS100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the HEMS100 may be configured to include one or a plurality of the devices shown in the drawings or may be configured without including some of those devices.

The functions of the HEMS 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the DR Activation prediction unit 103, mode determination unit 104, charge/discharge determination unit 108, comparison unit 107 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the mode determination unit 104 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing a power control method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described DR activation receiving unit 101 may be implemented by the communication device 1004. The communication device 1004 may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the HEMS100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way. Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

10: DC power supply system, 100: HEMS, 200: smart meter, 300: rectifier, 400: storage battery, 500: communication device, 600: commercial power supply, 101: DR activation receiving unit, 102: time management unit, 103: DR activation prediction unit, 104: mode determination unit, 105: data storage unit, 106: battery monitoring unit, 107: comparison unit, 108: charge/discharge determination unit, 301: rectification unit, 302: current sensor, 303: voltage sensor.

1. A power control device for controlling a storage battery to supply power to a load device, comprising:
a prediction unit that predicts activation of a demand response; and
a control unit that performs discharge control on the storage battery based on the activation prediction,
wherein the control unit changes a discharge timing of the storage battery depending on whether or not the activation of the demand response is predicted.

2. The power control device according to claim 1,
wherein, when the activation of the demand response is not predicted, the control unit discharges the storage battery at a predetermined peak time of power demand, and
when the activation of the demand response is predicted, the control unit discharges the storage battery based on an activation time included in a demand response request signal when the demand response request signal is received.

3. The power control device according to claim 2,
wherein, when the demand response request signal is received, the control unit ends the discharge of the storage battery based on an end time included in the demand response request signal.

4. The power control device according to claim 3,
wherein, when a predetermined charge start time comes after ending the discharge of the storage battery, the control unit charges the storage battery.

5. The power control device according to claim 1,
wherein, when a demand response request signal is received, the control unit ends discharge of the storage battery based on a state of charge of the storage battery.

6. The power control device according to claim 1,
wherein the storage battery is charged with power from a commercial power supply by a rectifier,
a backup capacity of the storage battery is set based on a rectifier voltage of the rectifier and a value of a current flowing through the load device, and
the control unit controls discharge of the storage battery based on a lower limit SOC set based on the backup capacity.

7. The power control device according to claim 6,
wherein the lower limit SOC that is a reference for allowing discharge is set based on a charging time zone for the storage battery and charging power for the storage battery.

8. The power control device according to claim 6,
wherein, when the storage battery reaches a fully charged state, the control unit sets the rectifier voltage of the rectifier to be approximately the same as a voltage of the storage battery to prevent overcharging.

9. The power control device according to claim 1, further comprising:
an acquisition unit that acquires a prediction or notification of occurrence of a disaster,
wherein, when a disaster is predicted, the control unit performs a process of charging the storage battery without waiting for a predetermined charge start time.

10. The power control device according to claim 1, further comprising:
a detection unit that detects a power outage,
wherein, when the power outage is detected, the control unit performs discharge processing regardless of a predetermined discharge start time.
